(19) United States
(12) Patent Application Publication
(10) Pub. No.: US 2013/0101352 A1
(43) Pub. Date: Apr. 25, 2013

(54) SYSTEM AND PROCESS FOR FLUE GAS PROCESSING

(71) Applicant: MARC VIANELLO, OVERLAND PARK, KS (US)

(72) Inventor: MARC VIANELLO, OVERLAND PARK, KS (US)

(21) Appl. No.: 13/279,109

(22) Filed: Oct. 21, 2011

(51) Int. Cl. B65G 5/00

(52) U.S. Cl. 405/59

(57) ABSTRACT

The present invention is directed to a method for sequestration of carbon dioxide, said method comprising the steps of injecting a waste gas into a subsurface containment region, providing a filter associated with a separation well for separating a constituent gas from the waste gas, the separation well being in communication with the subsurface containment region and evacuating at least a portion of the waste gas through the separation well for filtered separation of the constituent gas from the waste gas.

### CROSS-REFERENCE TO RELATED APPLICATION

This application claims priority under 35 U.S.C. 119(e) and 37 C.F.R. 1.78(a)(4) based upon copending U.S. Provisional Application Ser. No. 61/304,580 for SYSTEM AND PROCESS FOR FLUE GAS PROCESSING, filed Feb. 15, 2010, the disclosure of which is incorporated herein by reference.

### FIELD OF THE INVENTION

The present invention relates to a system and process for flue gas processing, more specifically to a system and process for processing and sequestration of flue gas constituents in subsurface structures. The present invention also relates to a system for using the gas processing to enhance hydrocarbon recovery from low pressure subsurface geological formations.

### BACKGROUND OF THE INVENTION

Increasing concentrations of greenhouse gases, including carbon dioxide, in the atmosphere are a subject of concern. It is feared that emission of these gases into the atmosphere could lead to global warming, sea-level changes, and different weather patterns, among other detrimental effects. Controlling the release of these gases into the atmosphere is thus an increasingly important concern. Response to this concern has lead to governmentally limited prohibitions and restrictions on carbon dioxide emissions, or fees associated with the emissions of such gases. Those approaches lead to high economic costs for industries that emit greenhouse gases, especially those that emit flue gases into the atmosphere.

In order to meet past and new emissions standards, several approaches have been developed to make flue gases cleaner. Some approaches to reduce the emissions of undesired components within various gases include using above ground technologies such as adsorption by microporous solids and chemical absorption. Other approaches include the geosequestration of purified gas in underground formations. However, current technologies have not developed systems or processes that make large scale sequestration of CO₂ financially feasible.

Rather than sequestering the CO₂, which currently is not financially feasible for most large-scale operations, some methods utilize it in purified form to enhance oil recovery from underground formations. However, using purified CO₂ for this purpose also presents a number of problems for the producer of the well. In most large-scale enhanced oil recovery operations utilizing purified CO₂, the primary cost of the recovery is the purchase of CO₂, which may represent operating costs as much as 68% of the total cost of the revenue from the project. The cost of acquiring purified CO₂ in large quantities is driven by the very high cost of separation of CO₂ from flue gases and its subsequent transportation to the sequestration site where it can then be injected into the subsurface formation. Moreover, the relative cost of large scale CO₂ capture, injection, and sequestration increases as oil prices decline.

Traditional configurations for hydrocarbon recovery processes require subterranean depths of greater than eight hundred meters, with a sufficient trapping mechanism and sufficiently porous geological texture to handle large volumes of injected gases. Different trapping mechanisms occur which vary depending on the associated structure and desired duration of the sequestration. In addition, traditional configurations require subsurface containment regions capable of receiving high flow injection rates under very high injection pressures to sustain CO₂ sequestration. Using the present invention, CO₂ sequestration is achievable at relatively shallower levels with reduced injection flow rates and pressures.

Despite the prior art's predominant usage of purified CO₂ in enhanced recovery methods, it is also possible to enhance the oil recovery process by using gases of differing compositions, such as those with compositions similar to common flue gases. Constituents of these mixtures may be at least partially soluble in hydrocarbons contained in the underground formation and in many situations the resulting solutions will experience a more favorable mobility due to decreased viscosity. In addition, the resulting low-cost pressurization of the underground containment region may promote increased recovery.

Moreover, potential sequestration locations for CO₂ injection are seldom located in close proximity to coal-fired electric power plants and other large scale flue gas sources. The cost of transporting purified liquid CO₂ by truck or pipeline is considerable. This circumstance exists for nonsequestration commercial markets of CO₂ as well. Therefore, the significant costs of carbon capture include the additionally significant costs of transporting liquefied CO₂ by tanker truck or pipeline. The combination of such energy costs and limited commercial demand for CO₂ do not make the sale of CO₂ captured by above-ground mechanical technologies commercially viable in many situations. For these reasons, neither sequestration nor the commercial sale of purified CO₂ are generally considered sufficient, practical, or financially feasible for utilizing all of the CO₂ contained in flue gases.

Additionally, the capital costs of the equipment necessary for large-scale separation and capture of CO₂ from power plant flue gases are enormous, generally in excess of $1.2 billion per plant.

Furthermore, the cost of large-scale separation and capture of CO₂ from flue gases has generally been considered commercially prohibitive for waste disposal due to the enormous volumes of energy required to condense the gases to the point where liquid CO₂ can be extracted. For a coal-fired electric power plant, estimates are that the energy cost of CO₂ separation can exceed by 30% to 40% the electricity production capacity of the plant. The result of combined capital and energy cost of large-scale CO₂ separation and capture from power plant flue gases could be very substantial increases in the price of electricity to consumers. Some estimates are that costs to consumers would need to double for the method of disposal to become commercial viability.

Some prior attempts at utilizing hydrocarbon recovery techniques have been described in Screening and Ranking of Hydrocarbon Reservoirs for CO₂ Storage in the Alberta Basin, Canada by Buchu, which is incorporated by reference.

Heretofore, there exists a need for an improved system and process for hydrocarbon recovery using emission gases sequestered in geological strata.

### SUMMARY OF THE INVENTION

The present invention is directed to a method for sequestration of carbon dioxide, said method comprising the steps of injecting a waste gas into a subsurface containment region, providing a filter associated with a separation well for separating a constituent gas from said waste gas, said separation well communicating with said subsurface containment region and evacuating at least a portion of the waste gas through the separation well for separation of the constituent gas from said waste gas by said filter.

### DETAILED DESCRIPTION OF THE INVENTION

Detailed embodiments of the present invention are disclosed herein; however, it is to be understood that the disclosed embodiments are merely exemplary of the invention, which may be embodied in various forms. Therefore, specific structural and functional details disclosed herein are not to be interpreted as limiting, but merely as a representative basis for teaching one skilled in the art to variously employ the present invention in virtually any appropriately detailed structure.

An exemplary embodiment of the system and process for production of hydrocarbon using the sequestration of carbon dioxide is comprised of a flue gas source, a means of compressing gas, a subsurface containment region, a separation well, and a means of filtering gas. A further embodiment includes a means of recycling a desired portion of gas produced through the separation well back into the subsurface containment region. A further embodiment includes means of producing hydrocarbons and other minerals from the subsurface containment region, capturing any transient gases produced with the hydrocarbons, and returning them to the containment region before or after applying the aforementioned means of filtering gases. The subsurface containment region is in communication with a compression source spaced apart from the subsurface containment region. The compression source is in communication with the flue gas source. The subsurface containment region includes a vessel, a formation, or other structure which surrounds its perimeter. As illustrated, the flue gases are injected into the subsurface containment region from the compression source and are dispersed throughout. Flue gases associated with the subsurface containment region are then allowed to flow through the separation well and pass through the filter associated therewith separating some of the constituent gases, particularly N₂, from the CO₂ and other gases that, together with N₂, comprise the flue. As these constituent gases are separated, the N₂ is removed from the system while the remaining gases are recycled back into the subsurface containment region.

Flue gases from various industrial processes (See Table 1-1) may be utilized in the present invention. These Flue gases can have a varying concentration as illustrated in FIG. 1 with the ratio of N₂ to CO₂ being illustrated in a triangle graph along with other trace gases such as water vapor, oxygen etc. As illustrated, at each end of the triangle industrial processes associated with high concentrations of N₂, CO₂ and other gases are shown. In which A represents the Oxygen-Coal processes associated with the upper limit of industrial process waste streams. B represents typical dry flue gas exhaust, C represents typical Otto or diesel cycle engine exhaust, D represents gas turbine exhaust and E represents methanol fuel cell exhaust gasses. As described above, the present invention may remove some contaminants from the flue gas through a filtering or separation process. Typically, the industrial flue gas may be processed during or in association with the industrial process by strippers or scrubbers.

TABLE 1-1
Typical Carbon Dioxide Composition in Various Processes

| | | Other | |
|---|---|---|---|
| Process | % CO₂ | Components | Notes |
| Otto cycle (gasoline, CNG, | 6-15% | N₂—71% | Depends on load, |
| etc. engine) | | O₂—trace | 14% typical. |
| | | H₂O—13% | |
| | | Other—1-2% | |
| Diesel cycle | 12% | N₂—67% | |
| | | O₂—10% | |
| | | H₂O—11% | |
| | | Other—<0.5% | |
| Pulverized Coal Combustion | 11% | N₂—76% | O₂ and H₂O may |
| | | O₂—6% | typically |
| | | H₂O—6% | approach <1% |
| | | Other —<1% | |
| Coal fired IGCC | 7% | N₂—66% | |
| | | O₂—12% | |
| | | H₂O—14% | |
| | | Other —<1% | |
| Waste Incinerator | 6-12% | N₂—balance % | |
| | | O₂—7-14% | |
| | | H₂O—10-18% | |
| | | Other—<1% | |
| Natural Gas CC | 3% | N₂—76% | |
| | | O₂—14% | |
| | | H₂O—6% | |
| | | Other—<1% | |
| Oxygen-Coal process | 80-90% | N₂—6% | CO₂ can be con- |
| | | O₂—5% | centrated to |
| | | Ar—4% | about 98% after |
| | | Other—<1% | this process |
| Gas Turbine | 9% | N₂—72% | |
| | | O₂—15% | |
| | | Other—<5% | |
| Methanol Fuel Cell | 25% | H₂O—75% | |
| Natural Gas Processing | 96-99% | | Natural gas at |
| | | | the well may |
| | | | contain |
| | | | 2-70% CO₂ |
| Ethylene Oxide Production | 30-100% | | |
| Hydrogen or Ammonia | 30-100% | | |
| Production | | | |
| Coal to Liquids Fuel Process | 95-100% | | |

While the invention discloses using flue gas, other CO₂ containing gases such as, but not limited to those illustrated in Table 1-1 may be utilized in the present invention.

In one embodiment, before being injected into the containment region, the flue gas [14] is industrially processed to remove at least a portion of (1) undesirable particles, (2) sulfur dioxide, (3) nitrous oxides and (4) moisture. The resulting processed flue gas may have a composition that is, for example, 10.73% CO₂, 1.39% CO, 0.76% NOₓ, 0.03% SO₂, and 87.09% N₂, although percentages of constituent gases may vary. The composition of the flue gas obtained from the flue gas source may vary as to the nature and proportion of contaminants depending on the specific industrial process utilized to remove undesirable particles. The greater the concentration of CO₂, the more desirable the flue gas is for application of this invention. See “Carbon Capture and Storage (CCS) in Nigeria: Fundamental Science and Potential Implementation Risks,” Galadima & Garba (2008 SWJ Vol 3, No. 2): pages 95-99; and “The Future of Carbon Capture and Storage (CCS) in Nigeria,” Anastassia et al., (2009 SWJ Vol. 4, No. 3), pages 1-6, which are attached hereto and incorporated by reference.

If solvent absorption of carbon dioxide is used for CO₂ sequestration, and monoethanolamine is the solvent, reactions with diatomic oxygen, nitrous oxides, and sulfoxides may lead to numerous operational problems such as foaming, fouling, increased viscosity, and formation of undesirable salts. Diatomic oxygen concentrations in the range of about 3% to 12% in typical flue gas streams are known to induce oxidative degradation of alkanolamines, resulting in severe corrosion of associated piping. Thus, solvent absorption techniques do not provide an effective means of achieving CO₂ sequestration of flue gases with CO₂ content at least 3% or greater. Additional information on contaminants and flue gas processing is disclosed in Supap, T; Idem, R.; Tontiwachwuthikul, P.; Saiwan, C., “Analysis of Monoethanolamine and Its Oxidative Degradation Products During CO₂ Absorption from Flue Gases: A Comparative Study of GC-MS, HPLC-RID, and CE-DAD Analytical Techniques and Possible Optimum Combinations,” Industrial & Engineering Chemistry Research, 2006, 45 (8), 2437, which is incorporated by reference.

While pressurization of subterranean formations may be generally understood, by using a CO₂ enriched gas, unexpected benefits may be achieved through a reduction in the processes necessary to achieve hydrocarbon recovery.

In one embodiment, the flue gases may be injected into the subsurface containment region through a compression source such as an injection well extending from the surrounding structure opposite the subsurface containment region into the subsurface containment region. See for example American Petroleum Institute, 2007, Background Report, “Summary of Carbon Dioxide Enhanced Oil Recovery (CO₂ EOR) Injection Well e Technology”, 1220 L Street NW, Washington, D.C., attached hereto and incorporated by reference. Some exemplary subsurface containment regions may include depleted oil and gas reservoirs, saline aquifers, coal beds and artificial vessels designed to sustain the hydrocarbon production. The injection well, which may be in communication with a production well, is used to inject the flue gases into the subsurface containment region, where the pressurized gas enhances the recovery of hydrocarbons. Optionally, the subsurface containment region may be sealed from the ambient surface environment allowing for a long term storage reservoir for CO₂. Optionally, enhanced hydrocarbon recovery and CO₂ containment may be practiced in combination.

After a portion of the CO₂ is sequestered from the flue gas, it may diffuse through the pores of the subsurface containment regions or associated brine and hydrocarbon zones. Saline structures may also present additional characteristics for containing the sequestered CO₂ or an impermeable capping material may be located between the injection well and the injected flue gases to seal the injected gases. The impermeable cap may include but is not limited to solid, liquid, or gaseous materials which limit undesired migration of sequestered CO₂.

In an alternative embodiment, mechanical surface compression may be utilized to inject the flue gas into the subsurface containment region and for pressurization thereof.

During enhanced oil recovery (EOR), typically representing the secondary stage of oil recovery, a subsurface containment region for EOR may have various degrees of suitability, depending on the intrinsic subsurface characteristics and the chemical composition of the oil mixture.

The range of reservoir and fluid properties suitable for CO₂ miscible injection is quite wide; however, exemplary reservoirs for miscible applications should have oil saturation with API gravity >27° (light oils with density <900 kg/m3), saturation, So >25%, and reservoir pressure >7.6 mPa/s and ideally 1.4 mPa/s higher than the minimum miscible pressure (MMP) at the time of initial CO₂ injection. In addition, the containment barrier porosity should be greater than 15% with permeability >1 md. An oil reservoir pressure at the start of a conventional miscible CO₂ flood may be at 1.38 mPa/s above the minimum miscibility pressure (MMP) to achieve miscibility between CO₂ and reservoir oil. This means that the ratio between reservoir pressure and minimum miscible pressure normally should >1.

In an alternative embodiment, a network for EOR may be provided having a plurality of subsurface containment regions. The subsurface contaiment regions may be spaced a distance from each other having relatively limited geological interaction while being connected with a production system having a variety of valves and pipes for tranport of gas from a central location to facilitate the production of oil, which may then be transported to a central storage repository using a system of pipes and valves. To facilitate the EOR, the separated waste gas may be tranported through the production system to a second subsurface containment region.

Immiscible CO₂ flooding although less common, can occur in heavy, medium and light oils; nevertheless it may be applied to heavy and medium oils (<28° API gravity; 900+kg/m3 density). Some limited studies have shown that, under cyclic immiscible recovery conditions, gas injection mixtures containing from 10%-25% CO₂ have achieved exceptional oil recovery. More discussion on enhanced oil recovery results in varying conditions is disclosed in Rivas, O., Embid, S., and Bolivar, F., 1994. Ranking reservoirs for carbon dioxide flooding processes. SPE Paper 23641, SPE Advanced Technology Series, v. 2 (Rivas et al., 1994), which is incorporated by reference.

Disclosure of sequestration of CO₂ is included in U.S. Pat. App. Nos. 20070215350 and 20100000737, which are incorporated by reference.

Optionally, the storage of quantities of CO₂ from the flue gas injected into the subsurface containment region may be further increased if the subsurface containment region is pressurized. The pressurization may be increased to a point approaching but not equaling the fracture gradient of the subsurface containment region in order to achieve pressures and temperatures suitable for maximizing the storage capacity of the subsurface containment region for storing the flue gases and or to increase the drive mechanism to enhance the recovery of hydrocarbons. “Fracture gradient,” measured in pounds per square inch per feet depth, is the pressure that if applied to rock or similar object within a subsurface containment region, will cause that rock to physically fracture. The subsurface pressure of said subsurface containment region may be increased by one or more means such as mechanical compression at the surface of the injected flue gas, flooding the formation with water, and adding chemical agents to the flue gas and/or to the subsurface brine and/or hydrocarbon bearing zones. U.S. Pat. Nos. 6,491,053, 7,506,690, 7,341,102, 6,318,468 and 4,744,417 involve processes and apparatus for enhanced hydrocarbon recovery using CO₂ at varying pressures and is incorporated by reference.

In yet another embodiment, the contents of the subsurface containment region having liquid hydrocarbons may be produced at an enhanced rate because the injected gases have increased the formation pressure above the pre-injection pressure. An additional benefit of producing liquid hydrocarbons from the containment region is simultaneously expanding the void in which additional flue gases may be injected. Any gas produced with the liquid hydrocarbons can optionally be re-injected into the containment region. Through this process, increasing volumes of flue gases can be sequestered in the containment region.

In yet another embodiment, the contents of the subsurface containment region having a constituent gas other than CO₂ may be directed outside the subsurface containment region through the filter associated with the separation well into the atmosphere under controlled conditions, making the evacuated portions of the subsurface region available for receipt of additional gasses. Moreover, the pressure of the stored constituent gases in the subsurface region is relieved allowing additional flue gas to be injected therein. By way of example, a containment region sufficient to store flue gas having a volume of 0.4 billion cubic meters (Bcm) at 1 atm, the flue gas having a composition of 11% CO₂, and injecting the flue gas into the containment region with a final pressure of 41 atm (which is below the facture gradient of the formation), allows for the containment of 16.4 Bcm of flue gases.

Locating an active or passive filter at the separation well in association with a gaseous discharge stream, such as those available from Generon IGS may be utilized for filtering and selectively discharging gas. For example, using a filter in association with the discharge stream may release into the atmosphere N₂ gas containing <1.0% CO₂ at a flow rate of 100 standard cubic feet per hour (SCFH) at 100 psig from the formation. The filter provides for the return of excess CO₂ in the form of separated waste gas to be recyled back into the subsurface containment region with a volume of N₂ gas (also referred to herein as a constituent gas) being evacuated from the subsurface containment region through the seperation well and possibly released to the atmosphere to be replaced by additional flue gases injected into the formation.

Alternatively, a network of subsurface containment regions including a plurality of spaced apart subsurface formations may be interrconnected with a gas conduit system, including associated valves and pipes for desired tranportation of gas through the gas conduit, optionally from a central location. In this way, waste gas, separated waste gas or constituent gas may be transported through the gas conduit and injected into the second subsurface formation to increase its formation pressure and further facilitate EOR at the second subsurface formation. The second subsurface formation may additionally include a second injection well for direct injection of a waste gas at the second subsurface formation or injection into the gas conduit system.

An alternative embodiment may include the use of an injection well spaced from the subsurface formation but in gaseous flow communication therewith for injection of the waste gas thereat. As desired, the waste gas at the second subsurface formation may be evacuated and separated as described earlier with the evacuated gas being evacuated at a separation well associated with the second subsurface formation or a separation well associated with another subsurface formation.

Additionally, any produced hydrocarbons may be transported through a similar fluid conduit network including associated valves and pipes for tranportation, storage and collection of the liquid hydrocarbons at a central repository.

In one operational embodiment for sequestration of CO₂, the waste gas may be injected into a subsurface containment region and a portion of the waste gas may be passed through a separation well in communication with the subsurface containment region, at a filter associated with the separation well to separate a constutent gas from the waste gas, the separated waste gas being recyled into the subsurface containment region to increase the CO₂ concentration of the separated waste gas contained within the subsurface containment region as desired.

The membrane separation of gases may involve polymeric membrane materials that allow for the rapid passage of N₂ gas while minimizing the passage of CO₂ gas when applying a pressure gradient across the membrane. The relative rates of separation of CO₂ (being a slow gas) from the relatively fast discharge air containing N₂ may vary based upon the discharge pressure. Use of the filter will ensure the quality of the discharge and separated gasses. The polymeric membrane materials may be formed into hollow fibers packaged together with a casing surrounding the fibers. The ends of the fibers being directed toward an open end of the casing with a lateral side port being generally tangentially oriented. The N₂ having a relatively fast transport speed is transported through the fibers and discharged out the open end of the casing while the CO₂ having a relatively slow transport speed is collected on the sidewalls of the fibers and released out the lateral side port for recirculation within the subsurface containment region. The filter casing may contain millions of fibers. Optionally, compressed air may be used to transport the gas down the fibers from one end of the casing with the N₂ exiting from the opposing end.

The employment of the filter under these conditions to exhaust N₂ gas and concomitant replacement within the containment region of exhausted N₂ with flue gas allows for a nominal increase in the percent composition of the contained flue gases of 1% per year of operation, allowing the enrichment of the CO₂ content of the flue gas from 11% to 51% over a period of 40 years.

Filling, pressurizing, and filtering gases confined in the subsurface containment region allows for enhanced sequestration of CO₂. For example, one cubic meter of flue gas containing 11% CO₂ contains approximately 215 grams of CO₂. Filling a containment region with a volume of 0.4 Bcm of 11% CO₂ flue gas to 1 atm pressure would result in the confinement of 86,000 metric tons of CO₂. The pressurization of this containment region to 41 atm of flue gas containing 11% CO₂ would result in the confinement of 3.53 million metric tons of CO₂. Filtering and replace N₂ gas within the containment region as outline in previous embodiments, would allow the containment of over 16 million metric tons of CO₂ over a forty-year period.

In yet another embodiment, a portion of any CO₂ and other constituent gases may be captured and selectively released from the upper portion of the subsurface containment region using a monitoring system used to detect higher proportions of the flue gas constituent gases and pressure flows. In addition, the subsurface containment region may be provided with a mechanical body, such as a gas containment layer disposed near its upper portion. Disclosure of monitoring and gas containment systems is in U.S. Pat. Nos. 7,448,828 and 5,063,519, which are incorporated by reference. The contents of the mechanical body are re-injected through secondary compression back into the subsurface containment region under miscible or immiscible conditions, repeating the injection process previously described as desired.

The nature of CO₂ leakage behavior will depend on properties of the subterranean structure, primarily its permeability, and on the thermodynamic and transport properties of CO₂ as well as other fluids with which it may interact in the subsurface. At typical temperature and pressure conditions in the shallow crust (depth <5 km), CO₂ is less dense than water, and therefore is buoyant in most subsurface environments. Upward migration of CO₂ will occur whenever appropriate vertical permeability is available. Potential pathways for CO₂ migration to structurally high areas of subsurface containment regions include (1) migration through porous rock, and (2) migration along faults or fractures. More disclosure on CO₂ migration is in Assessment of the CO₂ Sealing Efficiency of Pelitic Rocks: Two-Phase Flow and Diffusive Transport, paper 536, presented at 7th International Conference on Greenhouse Gas Control Technologies, Vancouver, Canada. Sep. 5-9, 2004; Zweigel, P., E. Lindeberg, A. Moen and D. Wessel-Berg. Towards a Methodology for Top Seal Efficacy Assessment for Underground CO₂ Storage, paper 234, presented at 7th International Conference on Greenhouse Gas Control Technologies, Vancouver, Canada. Sep. 5-9, 2004; Gibson-Poole, C. M., R. S. Root, S. C. Lang, J. E. Streit, A. L. Hennig, C. J. Otto and J. Underschultz; Conducting Comprehensive Analyses of Potential Sites for Geological CO₂ Storage, paper 321, presented at 7th International Conference on Greenhouse Gas Control Technologies. Vancouver, Canada. Sep. 5-9, 2004; Lindeberg, E. The Quality of a CO₂ Repository: What is the Sufficient Retention Time of CO₂ Stored Underground?, in: J. Gale and Y. Kaya (eds.), Greenhouse Gas Control Technologies, Elsevier Science, Ltd., Amsterdam, The Netherlands, 2003; and Espie, T. Understanding Risk for the Long-Term Storage of CO₂ in Geologic Formations, paper 42, presented at 7th International Conference on Greenhouse Gas Control Technologies. Vancouver, Canada. Sep. 5-9, 2004, which are incorporated by reference.

In yet another embodiment, gaseous CO₂ from the flue gas may be directed to a capture zone where it is stored in the subsurface containment region by sealing its surrounding surface using known techniques, such as a containment barrier around the perimeter of the subsurface containment region. The containment barrier is composed of material with low gas permeability. The barrier may be composed of existing natural material such as caliche, calcrete, silicrete. Alternatively, the containment barrier may be composed of manmade material. U.S. Pat. App. No. 20090220303 discloses using containment barriers in sequestration and is incorporated by reference.

In yet another embodiment, the system further comprises a plurality of interconnected subsurface containment regions. The subsurface containment regions would be connected by valve piping to enable a greater storage capacity by increasing the effective volume of the system.

While the foregoing detailed description has disclosed several embodiments of the invention, it is to be understood that the above description is illustrative only and not limiting of the disclosed invention. It will be appreciated that the discussed embodiments and other unmentioned embodiments may be within the scope of the invention.

Having thus described the invention, what is claimed as new and desired to be secured by Letters Patent is as follows:

1. A method for sequestration of carbon dioxide, said method including the steps of:
injecting a waste gas into a subsurface containment region;
providing a filter associated with a separation well for separating a constituent gas from said waste gas, said separation well communicating with said subsurface containment region;
evacuating at least a portion of said waste gas through said separation well for separation of said constituent gas from said waste gas by said filter; recycling said separated waste gas into said containment region; and
increasing the carbon dioxide concentration of the waste gas contained within said subsurface containment region.

2. The method of claim 1, wherein said waste gas is produced from an industrial process.

3. The method of claim 1 wherein said waste gas comprises substantially carbon dioxide and nitrogen gases and said separated waste gas comprises carbon-dioxide gas in greater concentration and nitrogen gas in lesser concentration than exists in said waste gas.

4. The method of claim 1, further comprising at least one compression source for injecting said waste gas.

5. The method of claim 1, further comprising a compression source associated with said separation well for separating said constituent gas from said waste gas.

6. The method of claim 1, further comprising the step of pressurizing said subsurface containment region to a level not exceeding its fracture gradient.

7. The method of claim 1, wherein said separated waste gas is injected into a second subsurface containment region.

8. The method of claim 1, further comprising the step of enclosing said subsurface containment region with a sealing surrounding surface.

9. The method of claim 1, wherein said subsurface containment region is a network of a plurality of spaced apart subsurface formations each in gaseous flow communication with each other through a gas conduit system.

10. The method of claim 11, wherein a second subsurface formation is pressurized from the separated waste gas of a first subsurface formation.

11. The method of claim 11 wherein said gas conduit system includes a second injection well associated with a second subsurface containment region.

12. A method for sequestration of carbon dioxide, said method including the steps of:
injecting a waste gas into a subsurface containment region;
providing a filter associated with a separation well for separating a constituent gas from said waste gas, said separation well communicating with said subsurface containment region; and
evacuating at least a portion of said waste gas through said separation well for separation of said constituent gas from said waste gas by said filter.
